(19) United States
(12) Patent Application Publication
(10) Pub. No.: US 2017/0083818 A1
(43) Pub. Date: Mar. 23, 2017

(54) INFORMATION PROCESSING APPARATUS, INFORMATION PROCESSING METHOD AND STORAGE MEDIUM

(71) Applicant: NEC Corporation, Tokyo (JP)

(72) Inventor: Yoshiyuki GOTO, Tokyo (JP)

(73) Assignee: NEC Corporation, Tokyo (JP)

(21) Appl. No.: 15/268,026

(22) Filed: Sep. 16, 2016

(30) Foreign Application Priority Data
Sep. 17, 2015 (JP) 2015-184098

(51) Int. Cl. G06N 5/04; G06N 99/00

(52) U.S. Cl. CPC G06N 5/04; G06N 99/005

(57) ABSTRACT

An information processing apparatus for determining an appropriate processing parameter of a predetermined process and obtaining processing time of the predetermined process, in a shorter period of time is provided. A learning support apparatus 500 includes an input unit 540 and an identifying unit 550. The input unit 540 receives input of new learning data. The identifying unit 550 identifies and outputs at least one of a value of a processing parameter and a value of processing performance of a learning process for the new learning data using history of processing performance of the learning process performed for learning data.

This application is based upon and claims the benefit of priority from Japanese Patent Application No. 2015-184098, filed on Sep. 17, 2015, the disclosure of which is incorporated herein in its entirety by reference.

### TECHNICAL FIELD

The present invention relates to an information processing apparatus, an information processing method and a program and in particular, relates to an information processing apparatus, an information processing method and a program which support execution of a predetermined process such as a learning process and the like.

### BACKGROUND ART

In recent years, there are many cases that machine learning techniques are applied to analysis of big data. For example, as an application of the above-mentioned machine learning techniques, “solution for demand prediction on daily foods” is known (“NEC starts selling a solution for retail trade which realizes a proper order by using big data analysis techniques”, [online], NEC Corporation, [retrieved on Aug. 31, 2015], the Internet <URL: http://jpn.nec.com/press/201504/20150410_01.html>).

In the “solution for demand prediction on daily foods” shown above, loss of sales opportunities due to discarding daily foods with a short expiration time or shortage of stock is reduced by using a prediction model which is constructed by machine learning, in retail trade such as a convenience store or a food supermarket. However, since a large variety of daily foods is handled by the retail trade, in order to construct a sufficiently accurate prediction model for the daily foods in limited time, it is necessary to perform parameter tuning for acquiring an appropriate processing parameter used in the machine learning.

In a model construction process of the machine learning, it is difficult to find out an analytic solution on the model, and consequently an iterative calculation, in which the model is constructed by iterating an update of the model, is performed in general. In such model construction process, it is necessary to determine an optimum value of a processing parameter of the iterative calculation such as iteration number, a threshold value which is used for ending the iterative calculation, and the like, with trial and error method. Since it takes several tens of minutes to several tens of hours to perform the model construction process each time even if a typical server machine is used, it takes much time to determine the appropriate processing parameter. Moreover, it is difficult for a user or the like to grasp a time taken to perform the model construction process, in advance.

An example of technique related to a support of the model construction process is described in Japanese Patent Application Laid-Open Publication No. 2015-014847. A “design support system” described in this patent literature obtains a processing time of a processing method for sample data of data to be processed, and predicts a processing time of the processing method for the data to be processed, based on the found-out processing time.

Note that, as a related art, a “dynamic correlation evaluation system” which indicates a change in one parameter caused by a change in the other parameter in a relational expression including a plurality of parameters is described in Japanese Patent No. 3682153. Moreover, a prediction apparatus which predicts class fields of a set of cases whose class fields are unknown, by using a set of cases whose class fields are known, is described in Japanese Patent Application Laid-Open Publication No. 2000-155681. A parameter estimation apparatus which generates a function group to estimate a parameter based on characteristic data of image data by using image data for learning, and estimates a parameter by using characteristic data of image data to be estimated and the function group is described in Japanese Patent Application Laid-Open Publication No. 2008-217521.

### SUMMARY

An object of the present invention is to provide an information processing apparatus, an information processing method, and a storage medium which can determine an appropriate processing parameter of a predetermined process and can obtain a processing time of the predetermined process, in a shorter period of time.

An information processing apparatus according to an exemplary aspect of the invention includes: an input unit that receives input of first data; and an identifying unit that identifies and outputs at least one of a value of a processing parameter and a value of processing performance of a predetermined process for the first data using history of processing performance of the predetermined process performed for second data.

An information processing method according to an exemplary aspect of the invention includes: receiving input of first data; and identifying and outputting at least one of a value of a processing parameter and a value of processing performance of a predetermined process for the first data using history of processing performance of the predetermined process performed for second data.

An non-transitory computer readable storage medium according to an exemplary aspect of the invention records thereon a program, causing a computer to perform a method including: receiving input of first data; and identifying and outputting at least one of a value of a processing parameter and a value of processing performance of a predetermined process for the first data using history of processing performance of the predetermined process performed for second data.

### BRIEF DESCRIPTION OF THE DRAWINGS

Exemplary features and advantages of the present invention will become apparent from the following detailed description when taken with the accompanying drawings in which:

FIG. 1 is a block diagram illustrating a characteristic configuration of an exemplary embodiment of the present invention;

FIG. 2 is a block diagram illustrating a configuration of a learning system in the exemplary embodiment of the present invention;

FIG. 3 is a block diagram illustrating a configuration of a learning support apparatus, which is realized by a computer, in the exemplary embodiment of the present invention;

FIG. 4 is a flowchart illustrating a collection process in the exemplary embodiment of the present invention;

FIG. 5 is a flowchart illustrating an identify process in the exemplary embodiment of the present invention;

FIG. 6 is a diagram illustrating an example of learning data in the exemplary embodiment of the present invention;

FIG. 7 is a diagram illustrating an example of a processing parameter in the exemplary embodiment of the present invention;

FIG. 8 is a diagram illustrating an example of processing performance in the exemplary embodiment of the present invention;

FIG. 9 is a diagram illustrating an example of generating a feature vector in the exemplary embodiment of the present invention;

FIG. 10 is a diagram illustrating an example of learning process information in the exemplary embodiment of the present invention;

FIG. 11 is a diagram illustrating another example of the learning data in the exemplary embodiment of the present invention;

FIG. 12 is a diagram illustrating an example of a processing performance requirement in the exemplary embodiment of the present invention;

FIG. 13 is a diagram illustrating another example of generating the feature vector in the exemplary embodiment of the present invention;

FIG. 14 is a diagram illustrating an example of extracting a similar feature vector in the exemplary embodiment of the present invention;

FIG. 15 is a diagram illustrating an example of a screen image in the exemplary embodiment of the present invention;

FIG. 16 is a diagram illustrating another example of the screen image in the exemplary embodiment of the present invention;

FIG. 17 is a diagram illustrating another example of the screen image in the exemplary embodiment of the present invention;

FIG. 18 is a diagram illustrating another example of the screen image in the exemplary embodiment of the present invention; and

FIG. 19 is a diagram illustrating another example of the screen image in the exemplary embodiment of the present invention.

### EXEMPLARY EMBODIMENT

Firstly, a predetermined process in an exemplary embodiment of the present invention will be described.

In the exemplary embodiment of the present invention, a case will be described in which a process of learning (constructing) a prediction model (hereinafter, also abbreviated as a model) is performed, as a predetermined process, using machine learning, as an example.

In the model construction process performed using the machine learning, a model is generated by searching for an optimum solution of a model parameter through iterating a model updating process for inputted data. As a method of performing such model construction process, there are many methods such as a neural network, a support vector machine, and a heterogeneous mixture analysis applied to the above-mentioned “solution for demand prediction on daily foods”. Prediction, identification, classification of data, or the like is performed based on the model constructed in the model construction process.

Into the model construction process, learning data for which a model is to be constructed is inputted. For example, as the learning data, a plurality of samples are inputted where each sample is defined as a set of values of plural attributes. The plural attributes are used as explanatory variables and an objective variable in the model.

The model construction process is performed according to a designated processing parameter. The processing parameter is a parameter which designates an operation of the model construction process, such as characteristics of the model to be constructed, a termination condition of the iterative processing, or the like. For example, as the processing parameter, “complexity of model” and “convergence degree of model” which designate the characteristics of the model, “condition for determining convergence” and “maximum iteration number” which designate the termination condition of the iterative processing, and the like are inputted.

In the model construction process, the model updating process is iterated and the model parameter is updated, until the termination condition of the iterative processing is satisfied. When the termination condition of the iterative processing is satisfied, the model construction process ends, and the final model parameter is outputted.

Next, a configuration according to the exemplary embodiment of the present invention will be described. Here, a learning system 1, which provides construction of a prediction model using the machine learning as Web service, will be described as an example.

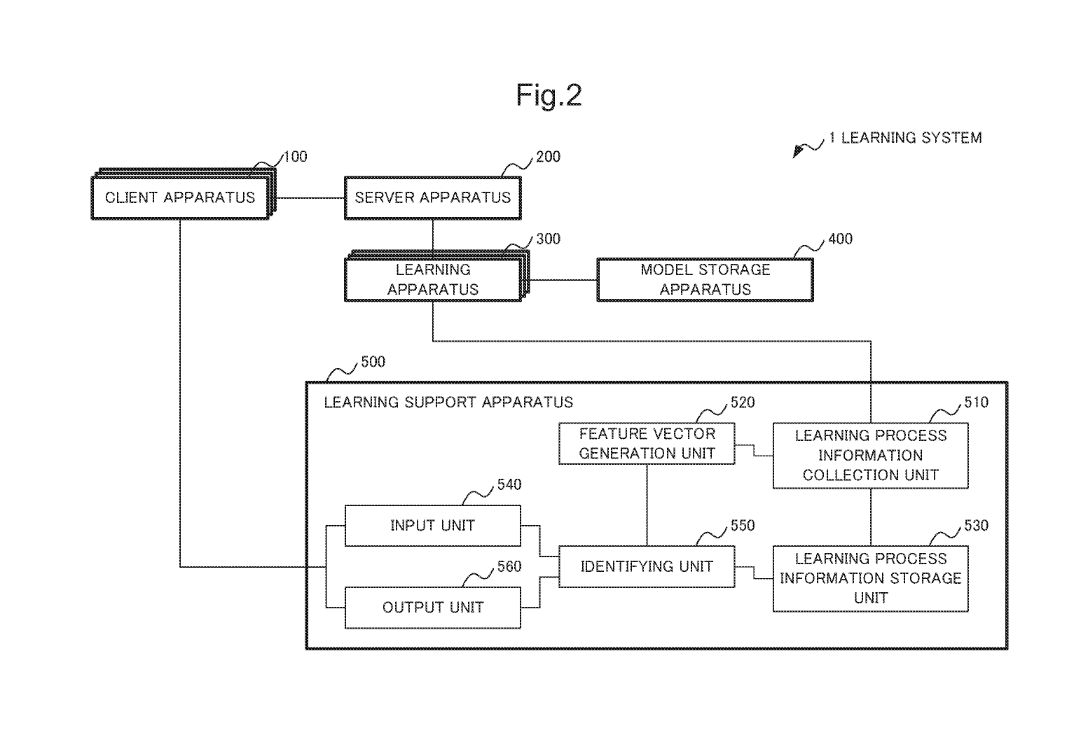

FIG. 2 is a block diagram illustrating a configuration of the learning system 1 in the exemplary embodiment of the present invention. The learning system 1 includes one or more client apparatuses 100, a server apparatus 200, one or more learning apparatuses 300, a model storage apparatus 400 and a learning support apparatus 500. The client apparatus 100 and the server apparatus 200, the client apparatus 100 and the learning support apparatus 500, the server apparatus 200 and the learning apparatus 300, and the learning apparatus 300 and the learning support apparatus 500 are connected via a network or the like.

The client apparatus 100 is, for example, a terminal apparatus such as a personal computer or the like. The client apparatus 100 sends a model construction request in which learning data (hereinafter, also referred to as second data) and a processing parameter for the model construction process are designated to the learning apparatus 300 through the server apparatus 200. Moreover, the client apparatus 100 sends a learning process information request in which new learning data (hereinafter, also referred to as first data) is designated to the learning support apparatus 500. The learning process information request is used for acquiring a processing parameter or processing performance (a processing time of the model construction process, an index for evaluation of the model) of the model construction process for the new learning data.

The server apparatus 200 provides the model construction by the learning apparatus 300 to the client apparatus 100, as Web service. The server apparatus 200 transfers the model construction request, which is received from the client apparatus 100, to the learning apparatus 300.

The learning apparatus 300 performs the model construction process to calculate processing performance of the model construction process, for the learning data designated in the model construction request received from the server apparatus 200, using the processing parameter designated in the model construction request.

The model storage apparatus 400 stores the model constructed by the learning apparatus 300.

The learning support apparatus 500 includes a learning process information collection unit 510, a feature vector generation unit 520, a learning process information storage unit 530, an input unit 540, an identifying unit 550 and an output unit 560. The learning support apparatus 500 is one exemplary embodiment of an information processing apparatus of the present invention.

The learning process information collection unit 510 collects learning data, a processing parameter and processing performance of the model construction process, from the learning apparatus 300.

The feature vector generation unit 520 calculates feature quantities which indicate a feature (characteristic) of the learning data, and generates a feature vector that includes the calculated feature quantities as elements.

The learning process information storage unit 530 stores learning process information 531. The learning process information 531 is information based on history of the model construction process. For example, the learning process information 531 is information in which a feature vector generated for learning data, a processing parameter for the model construction process, and processing performance of the model construction process performed for the learning data using the processing parameter are associated with each other. Here, the learning process information storage unit 530 may further store the learning data and the feature vector generated for the learning data in association with each other.

The input unit 540 receives input of the learning process information request from the client apparatus 100.

The identifying unit 550 extracts a feature vector, whose similarity to a feature vector of new learning data designated in the learning process information request is high, from the learning process information 531, and identifies a processing parameter and processing performance associated with the extracted feature vector.

The output unit 560 sends the processing parameter and the processing performance identified by the identifying unit 550 to the client apparatus 100, in response to the learning process information request.

Note that, the learning support apparatus 500 may be a computer which includes CPU (Central Processing Unit) and a storage medium storing a program, and operates by control based on the program.

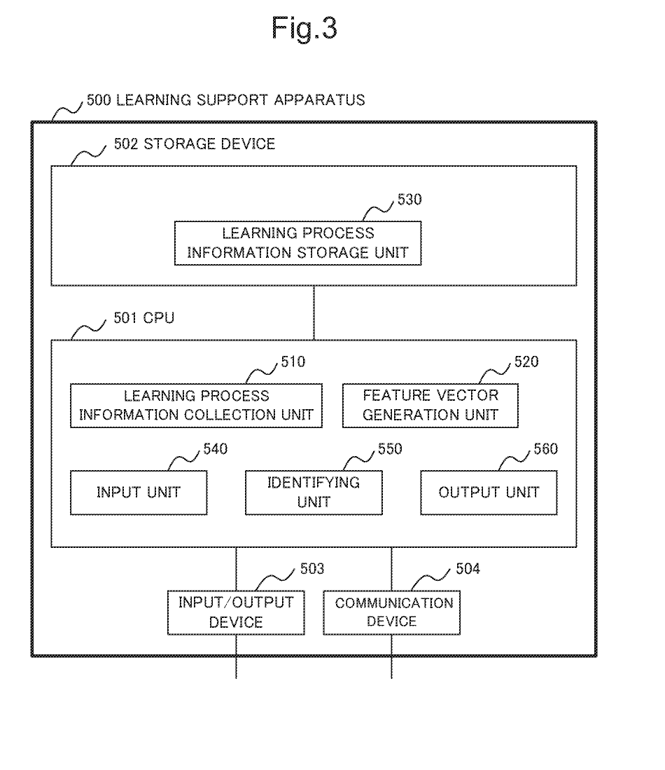

FIG. 3 is a block diagram illustrating a configuration of the learning support apparatus 500, which is realized by a computer, in the exemplary embodiment of the present invention.

In this case, the learning support apparatus 500 includes a CPU 501, a storage device 502 (storage medium) such as a hard disk, a memory or the like, an input/output device 503 such as a keyboard, a display or the like, and a communication device 504 which communicates with another apparatus or the like. The CPU 501 executes the program for realizing the learning process information collection unit 510, the feature vector generation unit 520, the input unit 540, the identifying unit 550 and the output unit 560. The storage device 502 stores data (learning process information 531) of the learning process information storage unit 530. The input/output device 503 receives input of the learning process information request issued by the client apparatus 100 and outputs the response to the learning process information request to the client apparatus 100. The communication device 504 receives learning data, processing performance and a processing parameter for the model construction process, from the learning apparatus 300.

Each component of the learning support apparatus 500 may be realized by a logic circuit. In this case, a plurality of components may be realized by one logic circuit and may be realized by a plurality of logic circuits which are separated.

Each component of the learning support apparatus 500 may be distributively arranged in plural physical apparatuses which are connected each other through a wired or wireless connection. In this case, the learning support apparatus 500 may be realized by distributed processing executed by a plurality of computers.

Next, the operation of the exemplary embodiment of the present invention will be described.

Firstly, a collection process in the exemplary embodiment of the present invention will be described.

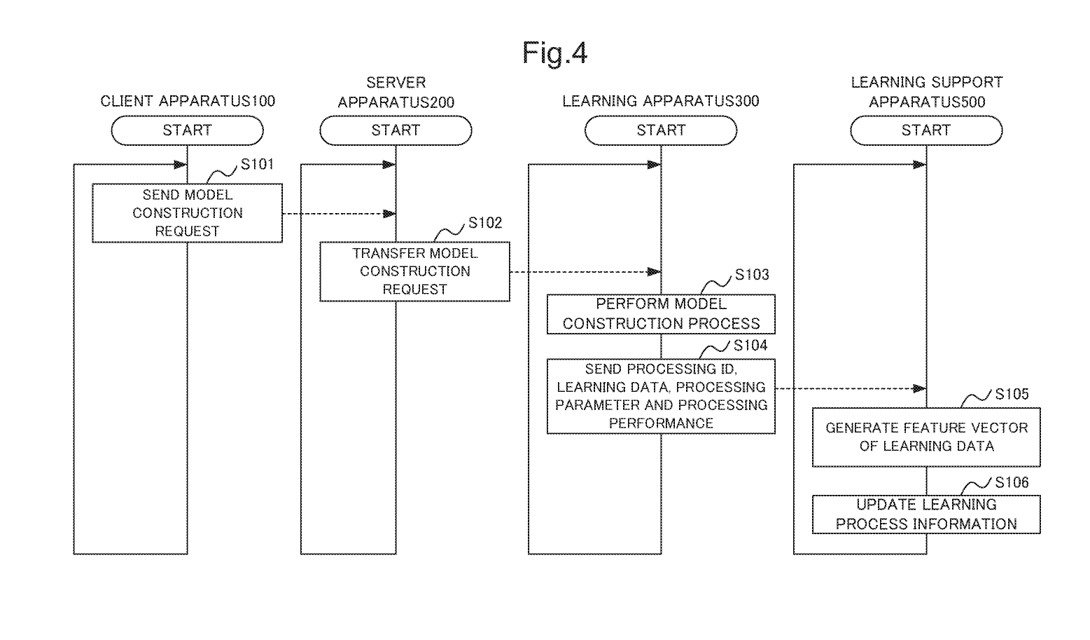

FIG. 4 is a flowchart illustrating the collection process in the exemplary embodiment of the present invention.

The client apparatus 100 sends the model construction request in which learning data and a processing parameter are designated, to the server apparatus 200 (Step S101).

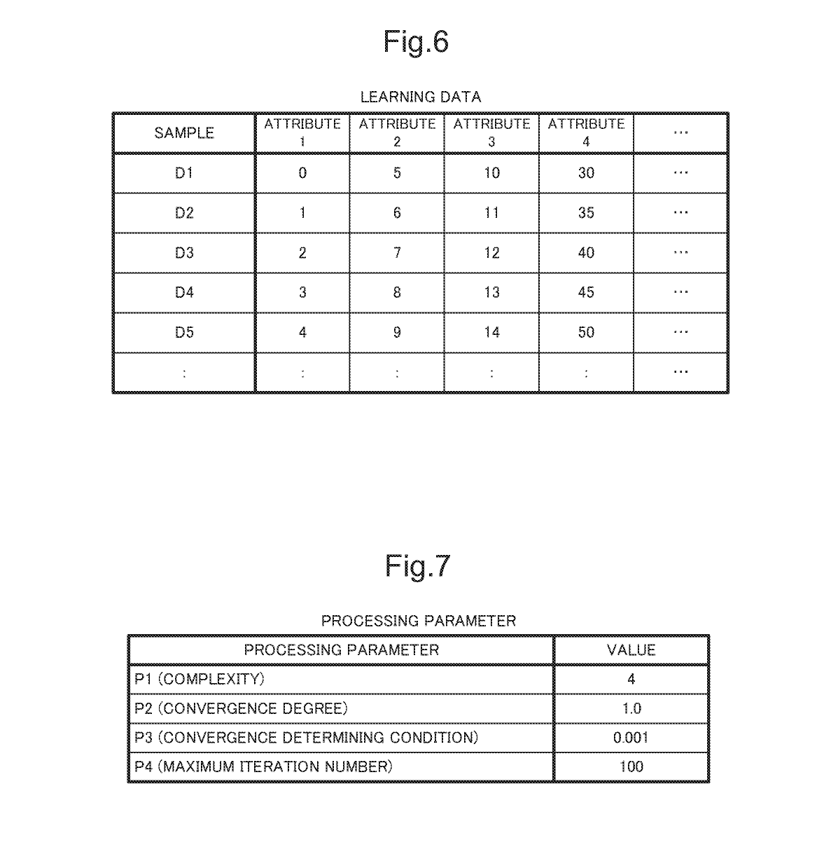

FIG. 6 is a diagram illustrating an example of the learning data in the exemplary embodiment of the present invention. In the example illustrated in FIG. 6, the learning data is expressed in a tabular form whose column represents the attribute (attributes 1, 2 . . . ) and whose row represents the set (sample) of attribute values. FIG. 7 is a diagram illustrating an example of the processing parameter in the exemplary embodiment of the present invention. In the lines 13 & 16 example of FIG. 7, P1, P2 . . . are designated as a processing parameter.

For example, the client apparatus 100 sends the model construction request in which the learning data illustrated in FIG. 6 and the processing parameter illustrated in FIG. 7 are designated.

The server apparatus 200 transfers the model construction request received from the client apparatus 100 to any one of one or more learning apparatuses 300 (Step S102).

The learning apparatus 300 performs the model construction process to construct a model for the learning data designated in the model construction request using the processing parameter designated in the model construction request (Step S103). The learning apparatus 300 stores the constructed model in the model storage apparatus 400. Furthermore, the learning apparatus 300 calculates processing performance of the model construction process. Here, as the processing performance, the learning apparatus 300 calculates a processing time of the model construction process, and an index for evaluation of the model constructed in the model construction process. As the index for evaluation of the model, for example, accuracy of the model such as a mean square error, the maximum value of an absolute error, or the like of a predicted value which is acquired by applying the learning data to the constructed prediction model, is calculated.

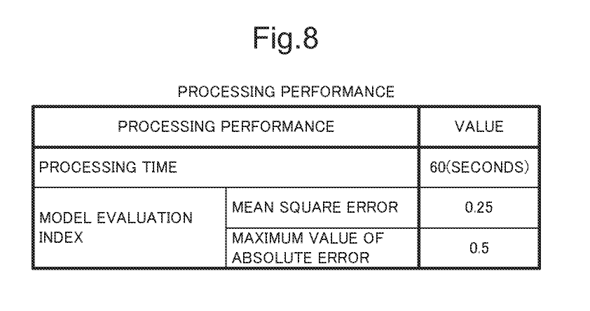

FIG. 8 is a diagram illustrating an example of the processing performance in the exemplary embodiment of the present invention. In the example of FIG. 8, as the processing performance, the processing time, the mean square error and the maximum value of the absolute error are indicated. For example, the learning apparatus 300 performs the model construction process for the learning data illustrated in FIG. 6 using the processing parameter illustrated in FIG. 7, and calculates the processing performance as illustrated in FIG. 8.

The learning apparatus 300 sends the learning data and the processing parameter used in the model construction process, and the calculated processing performance, to the learning support apparatus 500, with a processing ID (Identifier) which can uniquely identify each model construction process (Step S104).

For example, the learning apparatus 300 sends the learning data illustrated in FIG. 6, the processing parameter illustrated in FIG. 7 and the processing performance illustrated in FIG. 8 with the processing ID “100”.

The learning process information collection unit 510 of the learning support apparatus 500 receives (collects) the processing ID, the learning data, the processing parameter and the processing performance from the learning apparatus 300.

The learning process information collection unit 510 generates a feature vector of the collected learning data using the feature vector generation unit 520 (Step S105).

Here, the feature vector generation unit 520 performs pre-processing such as cleansing, standardization, removal of an attribute which has a strong correlation with another attribute, for the learning data. Here, as the cleansing, removal of an invalid value or complementation is performed. As the standardization, normalization is performed in such a way that an average and a variance are equal to 0 and 1 respectively, for example. Furthermore, either one of two attributes (explanatory variables) between which a strong correlation exists is removed.

Then, the feature vector generation unit 520 calculates, as a feature quantity, the number of samples and the number of the attributes of the pre-processed learning data. Furthermore, the feature vector generation unit 520 calculates a feature quantity with respect to attribute values of the pre-processed learning data. Here, the maximum values are calculated for respective attributes, and the maximum value, an average value and the minimum value among the calculated maximum values are used as the feature quantities with respect to the attribute values. Similarly, the minimum values are calculated for respective attributes, and the maximum value, an average value and the minimum value among the calculated minimum values are also used as the feature quantities with respect to the attribute values. Moreover, frequencies which has the strongest frequency component are calculated for respective attributes, and the maximum value, an average value and the minimum value among the calculated frequencies are also used as the feature quantities with respect to the attribute values.

The feature vector generation unit 520 generates the feature vector whose elements are the calculated number of samples, the number of attributes and the feature quantities with respect to the attribute values.

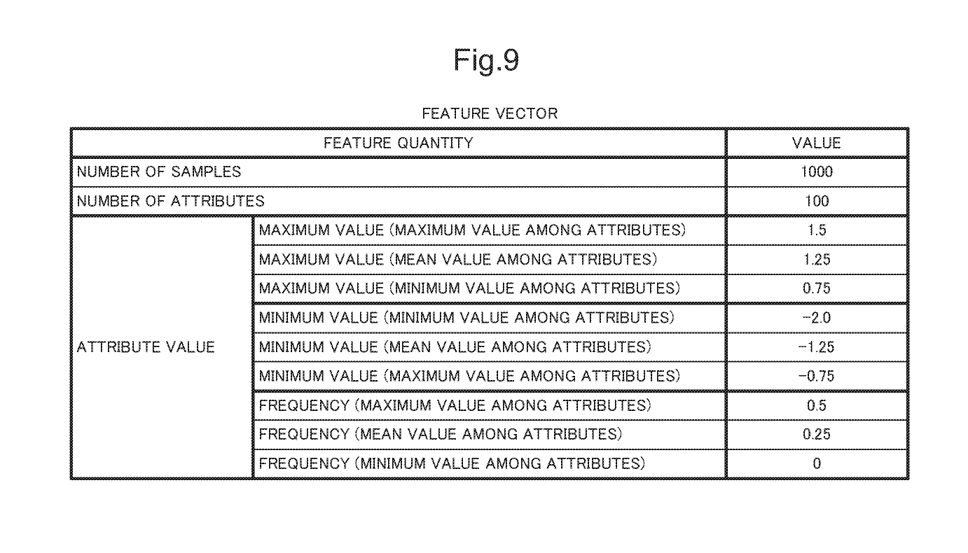

FIG. 9 is a diagram illustrating an example of generating the feature vector in the exemplary embodiment of the present invention. For example, the feature vector generation unit 520 generates the feature vector illustrated in FIG. 9 for the learning data illustrated in FIG. 6.

Note that the feature vector generation unit 520 may calculate another feature quantity as long as the feature quantity expresses a feature of the learning data. For example, the feature vector generation unit 520 may use a value of a principal component calculated by principal component analysis method or the like, as the feature quantity.

The learning process information collection unit 510 updates the learning process information 531 by adding the processing ID, the generated feature vector, the collected processing parameter and processing performance to the learning process information 531 in the learning process information storage unit 530 (Step S106).

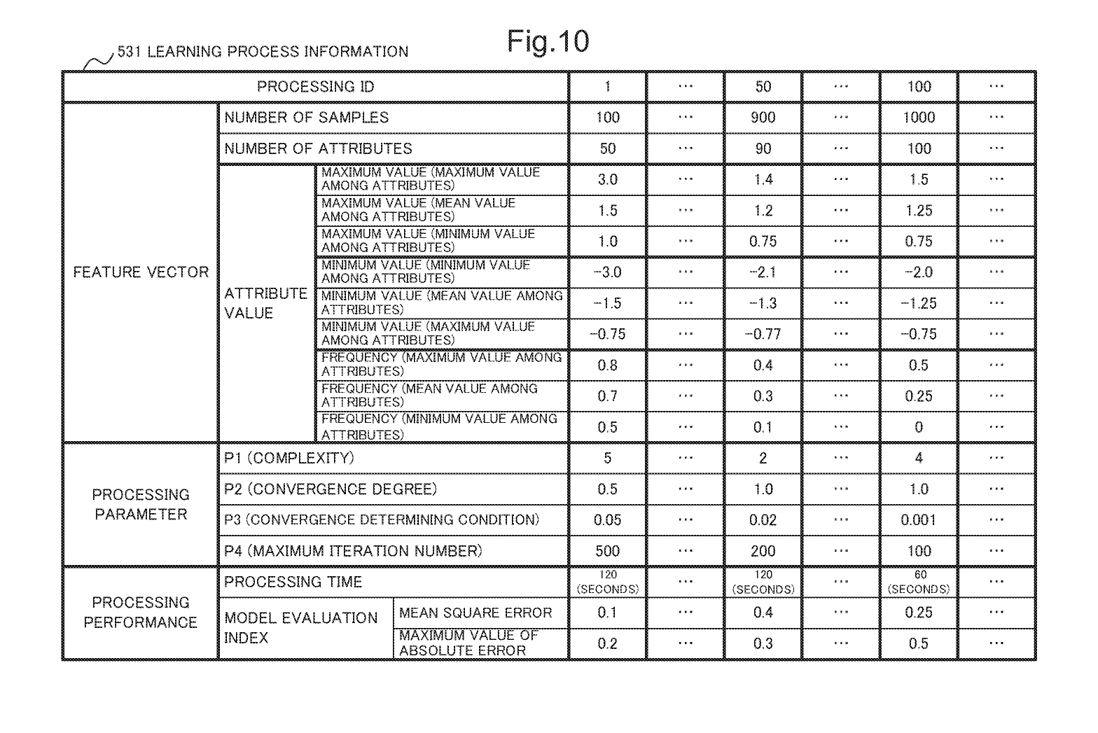

FIG. 10 is a diagram illustrating an example of the learning process information 531 in the exemplary embodiment of the present invention. For example, as illustrated in FIG. 10, the learning process information collection unit 510 adds the processing ID “100”, the feature vector illustrated in FIG. 9, the processing parameter illustrated in FIG. 7 and the processing performance illustrated in FIG. 8 to the learning process information 531.

Hereinafter, the processing from Step S101 is performed each time the learning apparatus 300 has performed the model construction according to the model construction request issued by the client apparatus 100. Then, various combinations of the feature vector, the processing parameter and the processing performance are recorded in the learning process information 531.

Next, an identifying process in the exemplary embodiment of the present invention will be described. Here, a case that the client apparatus 100 requests a processing parameter for new learning data and a processing performance requirement with a learning process information request, will be described as an example.

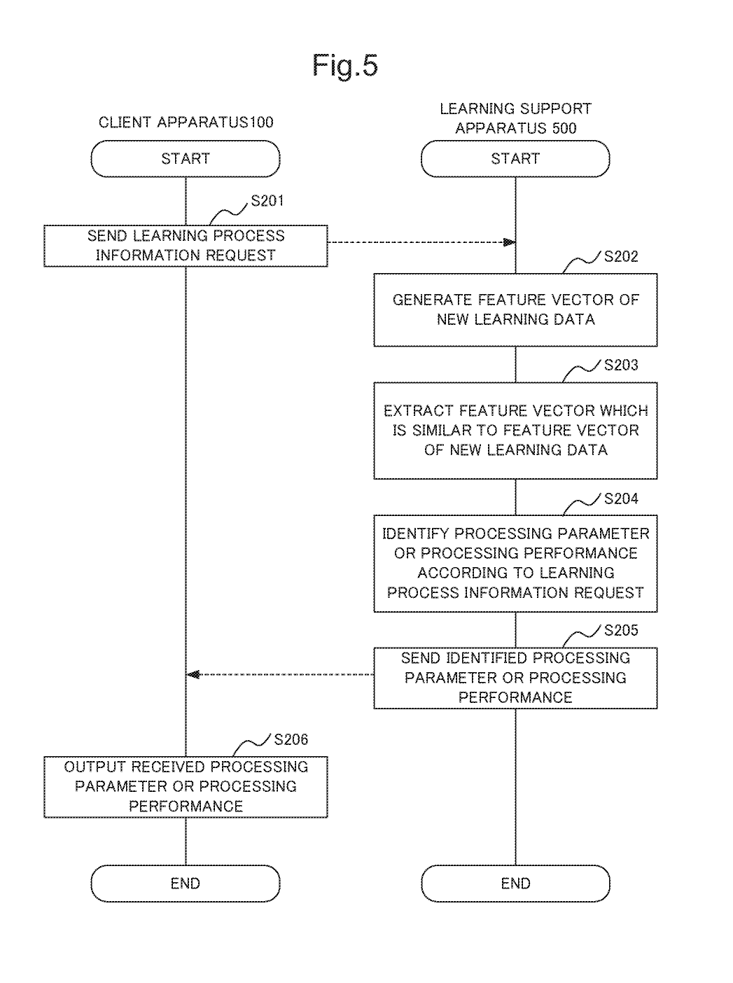

FIG. 5 is a flowchart illustrating the identifying process in the exemplary embodiment of the present invention.

The client apparatus 100 sends the learning process information request in which the new learning data and the processing performance requirement are designated to the learning support apparatus 500 (Step S201). The processing performance requirement is a required condition on processing performance (a processing time of the model construction process, and an index for evaluating the constructed model).

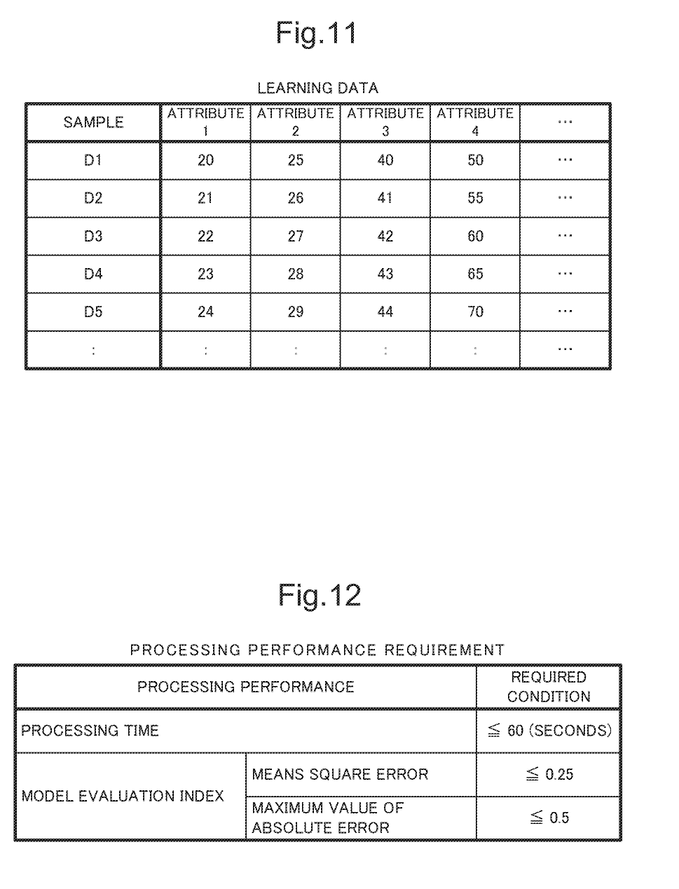

FIG. 11 is a diagram illustrating another example of the learning data in the exemplary embodiment of the present invention. FIG. 12 is a diagram illustrating an example of the processing performance requirement in the exemplary embodiment of the present invention. In the example of FIG. 12, required conditions on a processing time, a mean square error, and the maximum value of absolute error are illustrated as the processing performance requirement. For example, the client apparatus 100 sends the learning process information request in which the learning data illustrated in FIG. 11 and the processing performance requirement illustrated in FIG. 12 are designated.

The input unit 540 of the learning support apparatus 500 receives the learning process information request from the client apparatus 100.

The identifying unit 550 generates a feature vector of the new learning data designated in the received learning process information request using the feature vector generation unit 520 (Step S202).

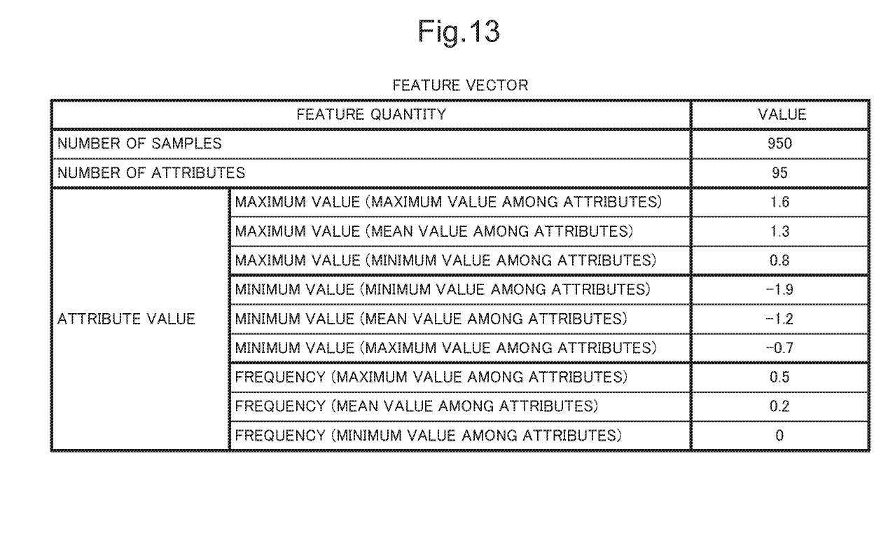

FIG. 13 is a diagram illustrating another example of generating the feature vector in the exemplary embodiment of the present invention. For example, the feature vector generation unit 520 generates the feature vector illustrated in FIG. 13 for the learning data illustrated in FIG. 11.

The identifying unit 550 extracts a feature vector which is similar to the feature vector of the new learning data designated in the learning process information request, from the learning process information 531 stored in the learning process information storage unit 530 (Step S203). Here, the identifying unit 550 extracts a feature vector having the number of samples and the number of attributes whose differences from those of the feature vector of the new learning data are equal to or smaller than predetermined difference thresholds respectively, and having cosine similarity of feature quantities of attribute values to that of the feature vector of the new learning data being equal to or smaller than a predetermined similarity threshold, for example.

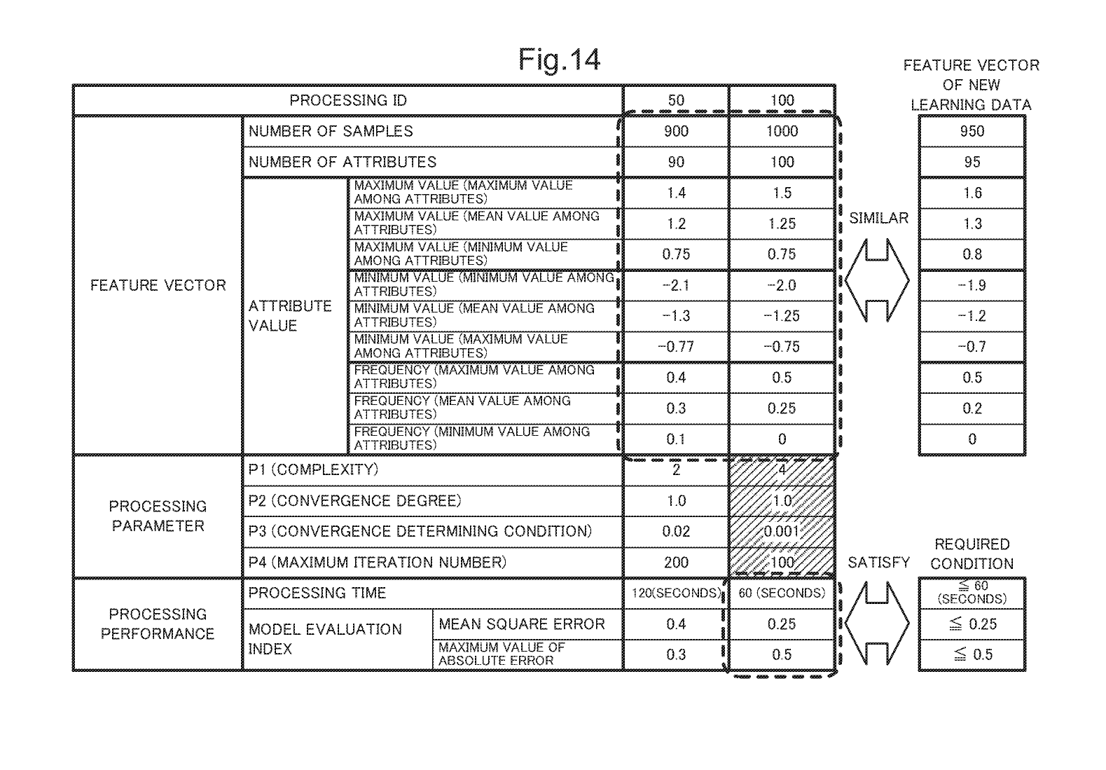

FIG. 14 is a diagram illustrating an example of extracting the similar feature vector in the exemplary embodiment of the present invention. For example, as illustrated in FIG. 14, the identifying unit 550 extracts feature vectors associated with the processing IDs “50” and “100”, from the learning process information 531 illustrated in FIG. 10 as a feature vector which is similar to the feature vector illustrated in FIG. 13.

The identifying unit 550 furthermore identifies a processing parameter or processing performance according to an instruction in the learning process information request, based on the processing parameter and the processing performance associated with each of the feature vectors extracted in Step S203 (Step S204). Here, the identifying unit 550 identifies the processing parameter associated with the processing performance satisfying the processing performance requirement, out of the processing parameters which are associated with the feature vectors extracted in Step S203.

For example, in FIG. 14, out of the processing performance associated with the processing ID “50” and the processing performance associated with processing ID “100”, the processing performance associated with the processing ID “100” satisfies the processing performance requirement illustrated in FIG. 12. Accordingly, the identifying unit 550 identifies the processing parameter “P1:4, P2:1.0, P3:0.001 and P4:100” associated with the processing ID “100” as the processing parameter according to the learning process information request.

The identifying unit 550 sends (outputs) the processing parameter or processing performance identified in Step S204 to the client apparatus 100 through the output unit 560, in response to the learning process information request (Step S205).

The client apparatus 100 outputs (displays) the received processing parameter or processing performance to a user (Step S206).

Here, the identifying unit 550 may generate a screen image 551, with which the client apparatus 100 displays the identified processing parameter and processing performance to the user or the like, and send the generated screen image 551 to the client apparatus 100, and make the client apparatus 100 display the screen image 551 to the user. Alternatively, the client apparatus 100 may generate a similar screen image 551 based on information received from the learning support apparatus 500, and display the screen image 551 to the user.

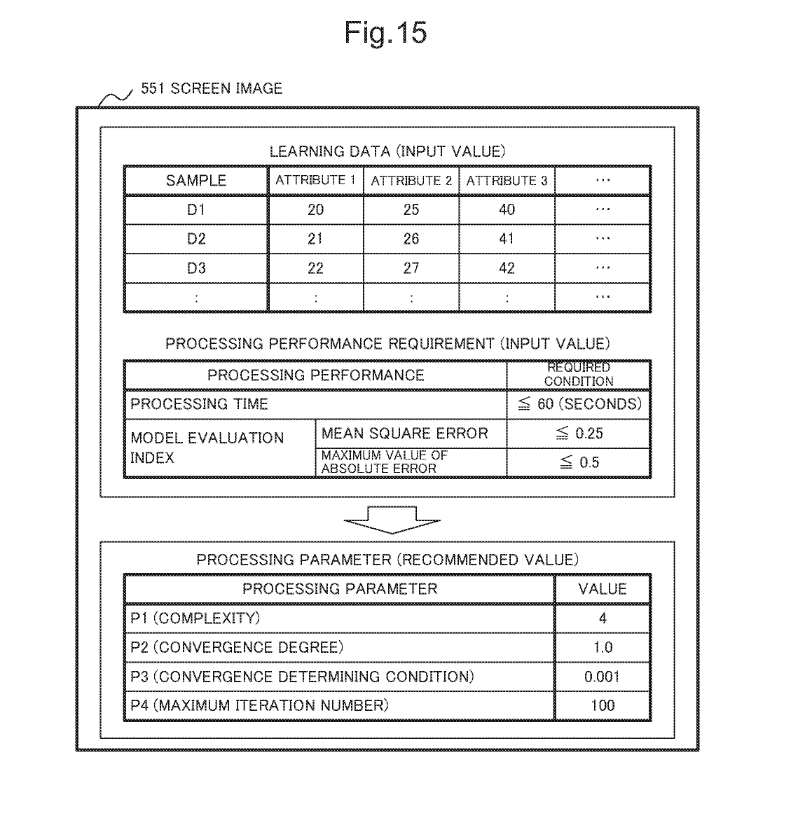

FIG. 15 is a diagram illustrating an example of the screen image 551 in the exemplary embodiment of the present invention. In the example of FIG. 15, the processing parameter (recommended value) identified for the learning data (input value) and the processing performance requirement (input value) designated in the learning process information request are illustrated.

For example, the identifying unit 550 generates the screen image 551 illustrated in FIG. 15 and makes the client apparatus 100 display the screen image 551.

The user can construct the model for the new learning data, which satisfies the processing performance requirement, by designating the processing parameter acquired from the screen image 551 illustrated in FIG. 15 in the model construction request for the new learning data.

As mentioned above, the user can acquire an appropriate processing parameter in such a way as to satisfy a processing performance requirement for new learning data, in a shorter period of time, without performing trial and error for determining the processing parameter.

Note that, in the case that the model construction is iterated for pieces of learning data whose features are similar but different each other, when a processing parameter is determined by performing the above-mentioned identifying process for one piece of learning data, it is expected to acquire almost the same processing performance by applying the same processing parameter to the other piece of learning data. Accordingly, in this case, it is possible to furthermore shorten a time required for determining the appropriate processing parameter.

By carrying out the above, the operation of the exemplary embodiment of the present invention is completed.

In the above-mentioned explanation, the case that the client apparatus 100 requests a processing parameter for new learning data and a processing performance requirement with the learning process information request has been described. However, the embodiment is not limited to the case. The client apparatus 100 may request processing performance for new learning data and a specific processing parameter with the learning process information request. In this case, the identifying unit 550 identifies, for example, based on processing performance associated with each of feature vectors which are similar to the feature vector of the new learning data, a processing performance related to a processing parameter which is identical or similar to the specific processing parameter, and sends the identified processing performance as an estimated value of the processing performance.

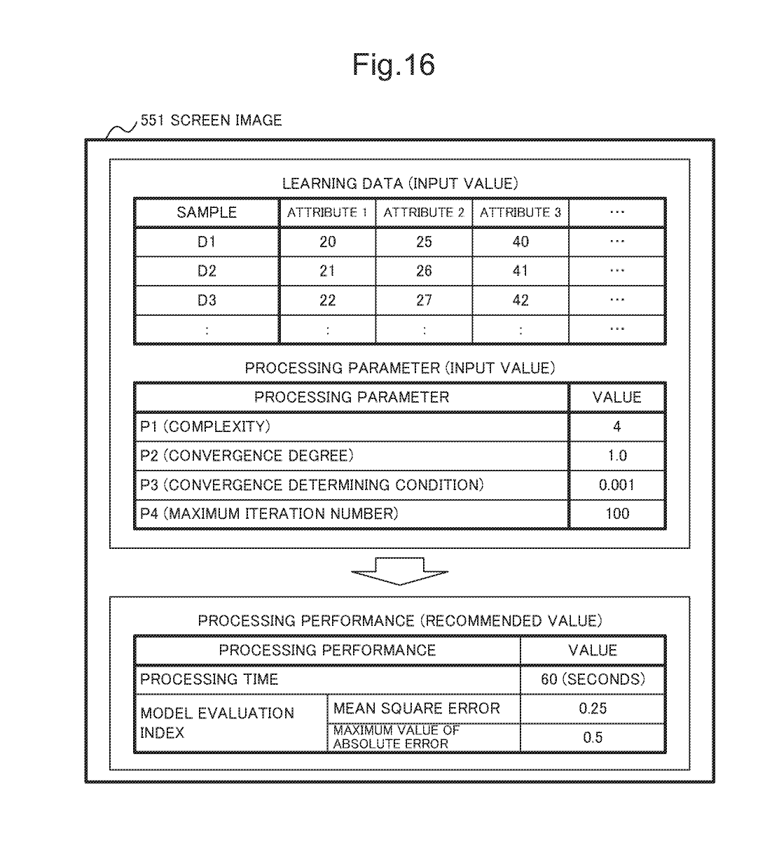

FIG. 16 is a diagram illustrating another example of the screen image 551 in the exemplary embodiment of the present invention. In the example of FIG. 16, the processing performance (estimated value) identified for the learning data (input value) and the processing parameter (input value) designated in the learning process information request. By reference to the screen image 551 illustrated in FIG. 16, the user can grasp the processing performance in the case that the model construction process for the new learning data is performed using the specific processing parameter.

Moreover, the client apparatus 100 may request a processing parameter and a processing performance for the new learning data with the learning process information request. In this case, the identifying unit 550 identifies and sends a combination of a processing parameter and a processing performance which are associated with a feature vector similar to the feature vector of the new learning data.

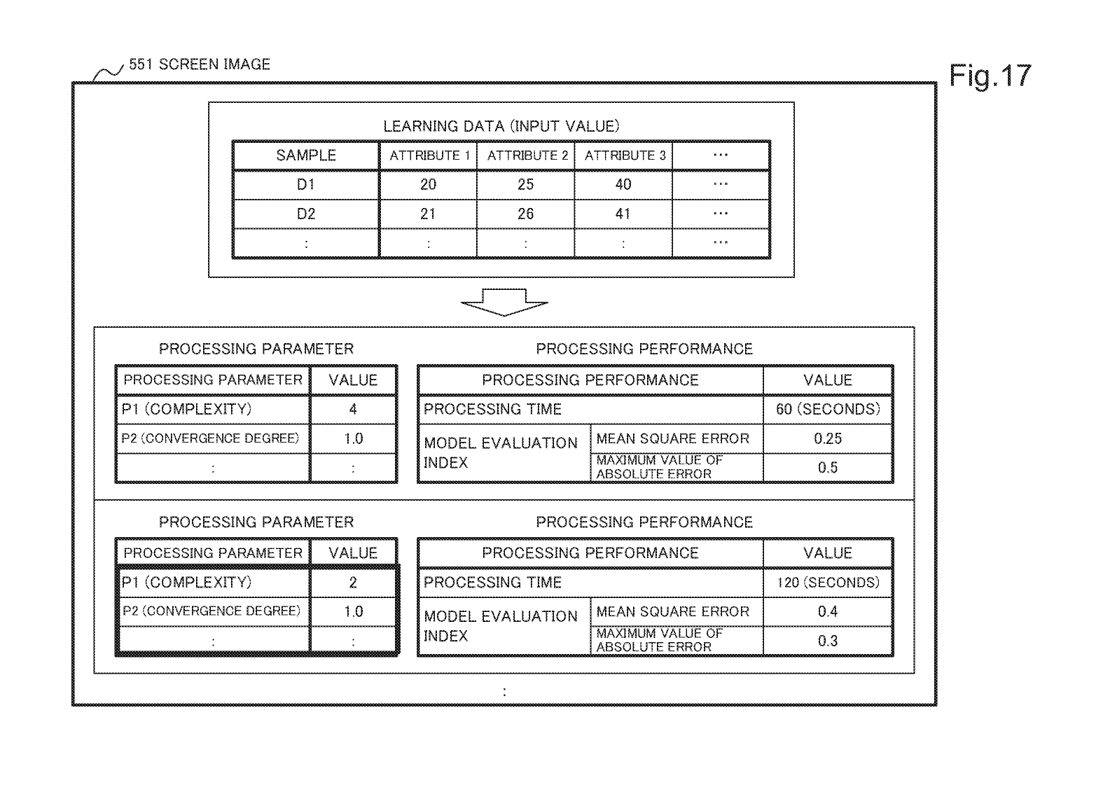

FIG. 17 is a diagram illustrating another example of the screen image 551 in the exemplary embodiment of the present invention. In the example of FIG. 17, combinations of the processing parameter and the processing performance which are identified for the learning data (input value) designated in the learning process information request are illustrated. By reference to the screen image 551 illustrated in FIG. 17, the user can grasp the processing performance in the case that the model construction process is performed for the new learning data using the various processing parameters.

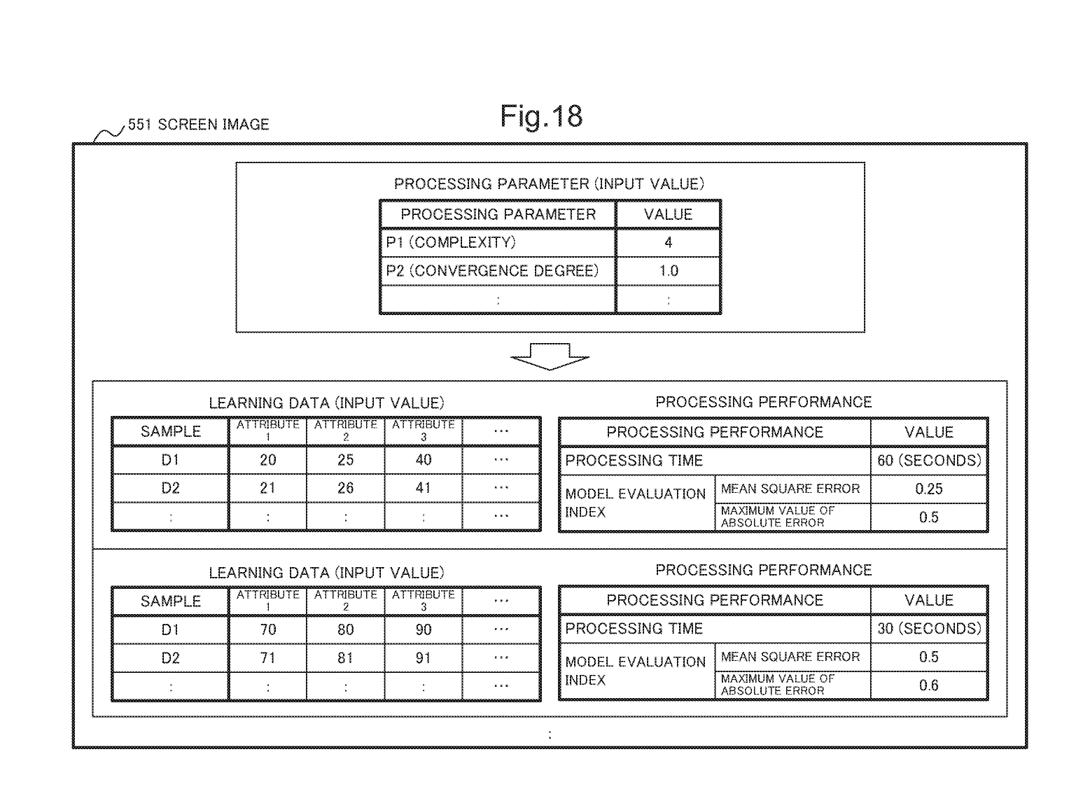

Moreover, the client apparatus 100 may request learning data and a processing performance corresponding to a specific processing parameter with the learning process information request. In this case, the identifying unit 550 identifies and sends a combination of learning data with respect to a feature vector and a processing performance which are associated with a processing parameter identical or similar to the specific processing parameter, for example. FIG. 18 is a diagram illustrating another example of the screen image 551 in the exemplary embodiment of the present invention. In the example of FIG. 18, combinations of the learning data and the processing performance which are identified for the processing parameter (input value) designated in the learning process information request are illustrated. By reference to the screen image 551 illustrated in FIG. 18, the user can grasp the processing performance in the case that the model construction process is performed for the various pieces of learning data using the specific processing parameter.

Furthermore, the client apparatus 100 may request learning data and a processing parameter for a processing performance requirement with the learning process information request. In this case, the identifying unit 550 identifies and sends a combination of learning data with respect to a feature vector and a processing parameter which are associated with a processing performance satisfying the processing performance requirement.

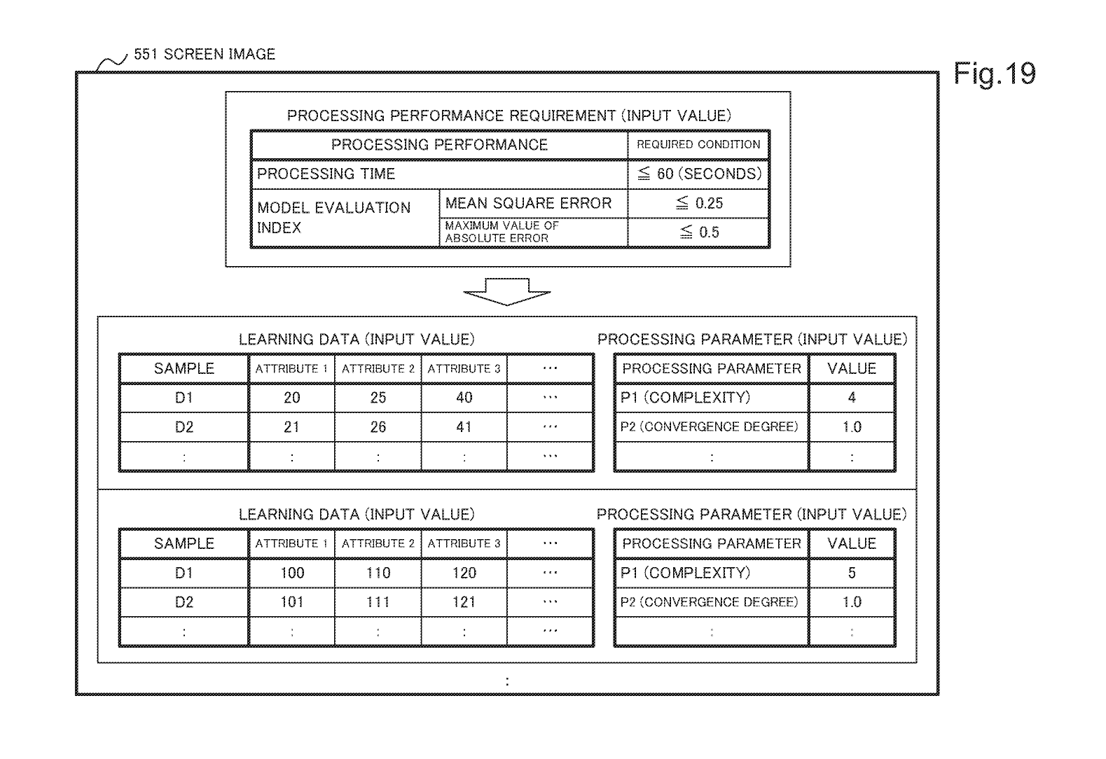

FIG. 19 is a diagram illustrating another example of the screen image 551 in the exemplary embodiment of the present invention. In the example of FIG. 19, combinations of the learning data and the processing parameter which are identified for the processing performance requirement (input value) are illustrated. By reference to the screen image 551 illustrated in FIG. 19, the user can acquire the appropriate processing parameter satisfying the processing performance requirement, for the various pieces of learning data.

Note that, on the screen images 551 illustrated in FIGS. 15 to 19, feature quantities of the learning data may be displayed in place of or together with the learning data.

According to the above-mentioned explanation, the identifying unit 550 extracts, from the learning process information 531, a feature vector having the number of samples and the number of attributes whose differences from those of the feature vector of the new learning data are equal to or smaller than predetermined difference thresholds respectively, and having cosine similarity of feature quantities of attribute values to that of the feature vector of the new learning data being equal to or smaller than a predetermined similarity threshold. Generally, if the feature of the learning data is similar and the differences in the number of samples and the number of attributes fall within certain ranges, it is conceivable that processing time of the model construction process depends on the number of samples and the number of attributes, and is almost proportional to the number of samples and the number of attributes. Accordingly, in the case that processing performance for new learning data and a specific processing parameter is requested, the identifying unit 550 may estimate more accurate processing time, which is taken for processing the new learning data, based on the processing time and the differences in the number of samples and the number of attributes for the extracted feature vector.

According to the above-mentioned explanation, the learning support apparatus 500 identifies a processing parameter for the learning data and the processing performance requirement designated in the learning process information request issued by the client apparatus 100, and sends the identified processing parameter to the client apparatus 100. However, the embodiment is not limited to the case. The learning support apparatus 500 may send the model construction request including the designated learning data and the identified processing parameter to the learning apparatus 300 to make the learning apparatus 300 construct a model. In this case, the learning support apparatus 500 may send the model construction request when the learning support apparatus 500 receives user's permission for constructing the model using the identified processing parameter, through the client apparatus 100. As a result, it is possible to construct the model satisfying the processing performance requirement for the new learning data without performing trial and error for determining a processing parameter.

Moreover, according to the exemplary embodiment of the present invention, the case that the predetermined process is the model construction process, which is performed using the machine learning, has been described. However, the embodiment is not limited to the case. The predetermined process may be a process other than the model construction process performed using the machine learning, as long as the process is performed for inputted data using a processing parameter, and different processing performances (a processing time, an evaluation index or the like) are acquired depending on the processing parameter. For example, the predetermined process may be an analysis process of image data or video data.

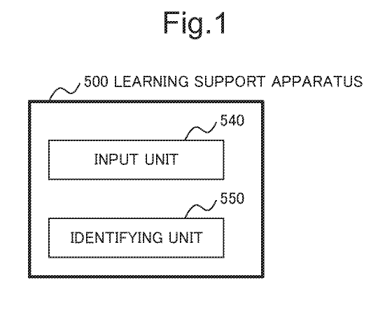

Next, a characteristic configuration of the exemplary embodiment of the present invention is described. FIG. 1 is a block diagram illustrating a characteristic configuration of the exemplary embodiment of the present invention.

Referring to FIG. 1, the learning support apparatus (information processing apparatus) 500 includes the input unit 540 and the identifying unit 550. The input unit 540 receives input of new learning data (first data). The identifying unit 550 identifies and outputs at least one of a value of a processing parameter and a value of processing performance of a learning process for the new learning data using history of processing performance of the learning process performed for learning data (second data).

Next, an advantageous effect of the exemplary embodiment of the present invention will be described.

According to the technique described in the above-mentioned Japanese Patent Application Laid-Open Publication No. 2015-014847, in order to obtain processing time of a processing method for data to be processed, it is necessary to perform the processing for sample data based on the processing method, and consequently it takes much time to find out the processing time dependently on the processing method and an amount of the sample data. In addition, the technique described in this patent literature does not disclose a method for determining a processing parameter of the processing method.

According to the exemplary embodiment of the present invention, it is possible to determine an appropriate processing parameter of a predetermined process and to obtain processing time of the predetermined process, in a shorter period of time. The reason is that the identifying unit 550 identifies and outputs at least one of a value of a processing parameter and a value of processing performance of a learning process for the new learning data using history of processing performance of the learning process performed for learning data.

As a result, it is possible to reduce a human resource and a machine resource required for determining an appropriate processing parameter and obtaining processing time for the predetermined process.

While the invention has been particularly described with reference to exemplary embodiments thereof, the invention is not limited to these embodiments. It will be understood by those of ordinary skill in the art that various changes in form and details may be made therein without departing from the scope of the present invention as defined by the claims.

What is claimed is:

1. An information processing apparatus comprising:
an input unit that receives input of first data; and
an identifying unit that identifies and outputs at least one of a value of a processing parameter and a value of processing performance of a predetermined process for the first data using history of processing performance of the predetermined process performed for second data.

2. The information processing apparatus according to claim 1, wherein
the identifying unit identifies at least one of the value of the processing parameter and the value of the processing performance relating to a characteristic of the first data, based on processing information in which a characteristic of the second data, a value of the processing parameter, and a value of the processing performance are associated, the value of the processing performance being acquired when the predetermined process is performed for the second data using the processing parameter.

3. The information processing apparatus according to claim 2, wherein
the identifying unit compares the characteristic of the first data with the characteristic of the second data included in the processing information, and identifies at least one of the value of the processing parameter and the value of the processing performance, which are associated with the characteristic of the second data and similar to those in the characteristic of the first data.

4. The information processing apparatus according to claim 2, wherein
the input unit receives input of the first data and a condition on the processing performance, and
the identifying unit identifies the value of the processing parameter associated with the processing performance satisfying the condition on the processing performance, out of the values of the processing parameter relating to the characteristic of the first data, based on the processing information.

5. The information processing apparatus according to claim 1, wherein
the processing performance includes a processing time of the predetermined process.

6. The information processing apparatus according to claim 1, wherein
the predetermined process is a learning process for constructing a model for data, and
the processing performance includes accuracy of the model generated by the learning process.

7. The information processing apparatus according to claim 2, wherein
the characteristic includes at least one of a maximum value, a minimum value and a frequency of each of plural attributes included in data.

8. An information processing method comprising:
receiving input of first data; and
identifying and outputting at least one of a value of a processing parameter and a value of processing performance of a predetermined process for the first data using history of processing performance of the predetermined process performed for second data.

9. The information processing method according to claim 8, wherein
in the identifying, at least one of the value of the processing parameter and the value of the processing performance relating to a characteristic of the first data is identified, based on processing information in which a characteristic of the second data, a value of the processing parameter, and a value of the processing performance are associated, the value of the processing performance being acquired when the predetermined process is performed for the second data using the processing parameter.

10. The information processing method according to claim 9, wherein
in the identifying, the characteristic of the first data is compared with the characteristic of the second data included in the processing information, and at least one of the value of the processing parameter and the value of the processing performance, which are associated with the characteristic of the second data and similar to those in the characteristic of the first data, is identified.

11. The information processing method according to claim 9, wherein
in the receiving, input of the first data and a condition on the processing performance is received, and
in the identifying, the value of the processing parameter associated with the processing performance satisfying the condition on the processing performance is identified, out of the values of the processing parameter relating to the characteristic of the first data, based on the processing information.

12. A non-transitory computer readable storage medium recording thereon a program, causing a computer to perform a method comprising:
receiving input of first data; and
identifying and outputting at least one of a value of a processing parameter and a value of processing performance of a predetermined process for the first data using history of processing performance of the predetermined process performed for second data.

13. An information processing apparatus comprising:
an input means for receiving input of first data; and
an identifying means for identifying and outputting at least one of a value of a processing parameter and a value of processing performance of a predetermined process for the first data using history of processing performance of the predetermined process performed for second data.
